(19) United States
(12) Patent Application Publication
(10) Pub. No.: US 2003/0134743 A1
(43) Pub. Date: Jul. 17, 2003

(54) Exhaust gas purifying catalyst and system and method of producing the catalyst

(76) Inventors: Hirosuke Sumida, Hiroshima (JP); Yuki Koda, Hiroshima (JP); Makoto Kyogoku, Hiroshima (JP); Hideharu Iwakuni, Hiroshima (JP); Hiroshi Yamada, Hiroshima (JP); Kenji Okamoto, Hiroshima (JP); Akihide Takami, Hiroshima (JP)

Correspondence Address: NIXON PEABODY LLP, Suite 800, 8180 Greensboro Drive, McLean, VA, 22102, US

(21) Appl. No.: 09/951,558

(22) Filed: Sep. 14, 2001

Related U.S. Application Data
(62) Division of application No. 09/159,592, filed on Sep. 24, 1998, now abandoned.

(30) Foreign Application Priority Data
Sep. 25, 1997 (JP) 9-259847
Sep. 14, 1998 (JP) 10-259529

(51) Int. Cl. B01J 23/02

(52) U.S. Cl. 502/304; 502/340; 502/341

(57) ABSTRACT

An exhaust gas purifying system and a catalyst used for the system prevents NOx absorbent from being poisoned by a sulfur compound to keep NOx absorption performance. The catalyst has at least an inner and an outer layer on a support material, the inner layer having NOx absorbent capable of absorbing NOx and a sulfur compound in the exhaust gas produced from combustion of a lean fuel mixture, releasing the NOx into the exhaust gas and substantially stopping absorbing the sulfur compound when a rich mixture is burnt, and the outer layer having a sulfur compound absorbent capable of absorbing the sulfur compound in the exhaust gas produced from combustion of a lean fuel mixture and capable of discharging the sulfur compound into the exhaust gas when a rich fuel mixture is burnt while the engine operates in a lean-burn zone. NOx is absorbed by the NOx absorbent in the inner layer and the sulfur compound is adsorbed in the sulfur compound absorbent in the outer layer. Therefor the NOx absorbent in the inner layer is protected from being poisoned by the sulfur compound.

### BACKGROUND OF THE INVENTION

1. Field of the Invention

The present invention relates to an exhaust gas purifying system for a vehicle, an exhaust gas purifying catalyst for use with the exhaust gas purifying system, and a method of producing the exhaust gas purifying catalyst.

2. Description of Related Art

It has been known that some exhaust gas purifying systems have a catalyst having NOx (nitrogen oxides) absorbent capable of absorbing NOx in the exhaust gas produced by the engine operating while a fuel mixture is lean and capable of discharging NOx into the exhaust gas when the oxygen concentration in the exhaust gas becomes lower so as thereby reduce the discharged NOx. However such a NOx absorbent also tends to absorb more SOx (sulfur oxide) rather than NOx in an exhaust gas, which causes the NOx absorbent to be poisoned with the SOx and then leads to significantly reducing the performance of the NOx absorbent.

With respect to avoiding a problem of SOx-poisoning described above, Japanese Unexamined Patent Publication 7-155601 discloses an improved catalyst having double catalytic layers carried on a support material, namely an inner or base layer which contains a NOx absorbent (one of alkaline earth metals), platinum (Pt) and alumina, and an outer or over layer which contains an oxide of a metal selected from a group of Fe, Co, Ni, Cu and Mn. This catalyst can avoid the SOx-poisoning problem because the metal oxide in the outer layer oxidizes SOx in the exhaust gas as SO₀₃ which produces a SOx salt to prevent the inner layer from being poisoned by SOx.

Japanese Unexamined Patent Publication 9-10601 discloses another improved catalyst having double catalytic layers carried on a support material, namely an inner or base layer which contains a NOx absorbent such as, platinum (Pt), palladium (Pd), barium (Ba) and alumina, and an outer or over layer which contains zeolite and ceria. In this catalyst, the zeolite in the outer layer prevents Ba in the inner layer from being poisoned. by sulfur.

Further, an exhaust gas purifying system is known from Japanese Unexamined Patent Publication 6-346768. This system is mainly comprised of two parts, i.e. first part of which is located upstream from a second part in an exhaust gas flow path. The first part has a SOx absorbent made of particles of, for example, copper (Cu), iron (Fe), manganese (Mn) and/or nickel Ni) supported on a support material and is capable of absorbing SOx in the exhaust gas produced while a lean air-fuel mixture burns and discharging SOx into the exhaust gas while a rich air-fuel mixture burns, and the second part has a NOx absorbent made of particles of, for example, alkaline metals, alkaline earth metals and/or rare earth metals, and noble metals supported on a support material and is capable of absorbing NOx in the exhaust gas produced while a lean air-fuel mixture burns and discharging NOx into the exhaust gas while a rich air-fuel mixture burns. The system has a bypass passage bypassing the second part and connected to a switching valve located between the first part and the second part. With the system, when a lean air-fuel mixture burns, the exhaust gas passes through the second part after flowing through the first part where SOx is absorbed and eliminated from the exhaust gas so that the NOx absorbent of the second part is prevented from being poisoned by Sox, or when a rich air-fuel mixture burns, the exhaust gas bypasses the second part so that the NOx absorbent of the second part is prevented from being poisoned by SOx which is discharged from the SOx absorbent of the first part.

### SUMMARY OF THE INVENTION

An object of the invention is to provide an improved catalyst, a simple exhaust gas purifying system equipped with the improved catalyst and a method of producing the improved catalyst.

It is another object of the invention to provide an improved catalyst which is capable of absorbing sulfur oxides, such as SOx and H₂S, in the exhaust gas under existence of oxygen and releases the sulfur oxides while the exhaust gas reduces its oxygen concentration and of preventing Nox absorbent from being poisoned by a sulfur compound.

The prior art catalyst disclosed in the above Japanese Unexamined Patent Publication 6-346768 uses the same type of SOx absorbent to prevent NOx absorbent from being poisoned by SOx. This prior art catalyst has SOx absorbent and NOx absorbent separately disposed upstream and downstream, respectively, in the exhaust line, so that it is necessary to provide an bypass passage and a switching valve which bypasses the NOx absorbent to isolate the NOx absorbent from SOx released from the SOx absorbent, which is always undesirable for a simple structure of exhaust gas purifying system.

The present invention uses a multiple layer catalyst comprising an inner layer which contains NOx absorbent formed on a support member and an outer layer which contains sulfur compound absorbent , which provides a simple structure of exhaust gas purifying system.

According to the invention, an exhaust gas purifying system having a support member, a exhaust gas purifying catalyst containing a NOx absorbing material for absorbing NOx in an exhaust gas from the engine under existence of oxygen and releasing the NOx while the exhaust gas reduces its oxygen concentration formed on the support member, and a oxygen concentration change means for changing the oxygen concentration of the exhaust gas. The catalyst comprises an inner layer, formed on the support member, which contains the NOx absorbing material and an outer layer, formed over the inner layer, which contains a sulfur compound absorbing material for absorbing sulfur oxides in the exhaust gas under existence of oxygen and releasing the sulfur oxides while the exhaust gas reduces its oxygen concentration.

With the exhaust gas purifying system, when the oxygen concentration control means increases the oxygen concentration of exhaust gas by, for example, providing a lean air-fuel ratio of the exhaust gas, on one hand, NOx in the exhaust gas is absorbed by the NOx absorbent in the inner layer, and, on the other hand, the sulfur compounds (SOx and H₂S) in the exhaust gas are adsorbed by the sulfur compound absorbent in the outer layer. Accordingly, the NOx absorbent in the inner layer is protected by the sulfur compound absorbent from being poisoned by sulfur compounds. When the oxygen concentration control means lowers the oxygen concentration of exhaust gas by, for example, providing a rich air-fuel ratio of the exhaust gas, on one hand, the NOx absorbent releases NOx which have been absorbed and, on the other hand, the sulfur compounds absorbent releases sulfur compounds. In the atmosphere of oxygen with a low concentration, the NOx absorbent is made hard to absorb sulfur compounds, so that it is protected from being poisoned by sulfur compounds released from the sulfur compound absorbent.

The oxygen concentration control means may change the oxygen concentration by controlling an air-fuel ratio of a fuel mixture so as to change it between a lean air-fuel ratio represented by an excess air factor (λ) greater than 1 (one) and a rich air-fuel ratio represented by an air excess factor (λ) equal to or less than 1 (one). Providing a lean air-fuel ratio rises the oxygen concentration of exhaust gas, so that the NOx absorbent and the sulfur compound absorbent works with improved absorbing performance. Providing a rich air-fuel ratio lowers the oxygen concentration of exhaust gas, causing the NOx absorbent to release NOx and the sulfur compound absorbent to release sulfur compounds. Further, the NOx absorbent does not perform substantial absorption of sulfur compounds, it is never poisoned by sulfur compounds released from the sulfur compound absorbent.

A large quantity of an oxide of cerium (Ce), zirconium (Zr), nickel (Ni), iron (Fe), cobalt (Co), vanadium (V) or titanium (Ti), or preferably either ceria (cerium oxide CeO₂) or a vanadium oxide (V₂O₅) alone, or a mixture of the two, may be employed as the sulfur compound absorbent. As both ceria and vanadium oxide are capable of starting release of sulfur compounds at a low temperature of, for example, about 500° C., it is advantageous in preventing a sulfur compound absorption capacity of the absorbent from being saturated. if the absorption capacity is saturated and substantially no sulfur compounds is absorbed, the NOx absorbent is made hard to be protected from being poisoned by sulfur compounds.

In the case of using ceria as the sulfur compound absorbent in the outer layer, the quantity of ceria is usually preferred to be between 80 and 360 g per one liter of the supporting member (which is hereafter referred to as 80 to 360 g/L). If the quantity amount is less than 80 g/L, the absorption capacity will be short, which may cause sulfur-poisoning of the NOx absorbent. While, as the quantity of ceria increases, the absorption capacity increases, there occurs no improvement of the capacity any more even when the quantity reaches over 360 g/L. Moreover, it becomes costly and cause clogging of cells of a honeycomb bed, if used as the support member, due to a thick seria layer and a decrease in cross sectional area of the cell.

It is preferable to provide an intermediate layer capable of activating NOx gas between the inner layer containing the NOx absorbent and the outer layer containing the sulfur compound absorbent. Usually alkaline earth metals or rare earth metals, typically such as Ba, are used as the NOx absorbent. In this case, the NOx absorption is mainly done through chemical adsorption process which needs activation of NOx. Thus forming the intermediate layer capable of activating NOx promotes NOx absorption by the NOx absorbent contained in the inner layer. As the activating material capablr of activating NOx contained in the intermediate layer, zeolite bearing noble metals thereon is preferably used, especially the zeolite bearing Pt or both Pt and Rh is more preferable.

It is preferred for the inner layer containing the NOx absorbent to contain further noble metals in view of reduction or deoxidization of NOx. Alkaline metals, alkaline earth metals and rare earth metals may be employed as the NOx absorbent.

The exhaust gas purifying catalyst which comprises a support member and a catalytic material disposed on the support member and containing a NOx absorbing material which absorbs NOx in an exhaust gas from an engine under existence of oxygen and releases said NOx absorbed thereby while the exhaust gas reduces its oxygen concentration is produced by a method of the invention which comprises the steps of: forming an inner layer for supporting a bearing material by which the NOx absorbing material is borne on the support member; forming an outer layer over the inner layer containing a basic compound which is harder to bear said NOx absorbing material than the support material; and impregnating the inner layer with a solution of the NOx absorbing material through the outer layer so as thereby to bear the NOx by the bearing material.

While, in order to bear NOx absorbent in an inner layer formed on a support layer, it is typical to form an outer layer over the inner layer after having borne the NOx absorbent in the inner layer. During forming the outer layer, the NOx absorbent in the inner layer partly moves into the outer layer or is partly removed from the inner layer. In such the case, it is preferred to impregnate the inner layer with a solution of NOx absorbent after having formed the outer layer over the inner layer. However, when employing the impregnation process, the NOx is also distributed in the outer layer.

According to the method of the invention, the outer layer is provided as a layer containing a basic compound by which the NOx is hard to be borne with an effect of bearing NOx greatly in the inner layer but small in the outer layer. While the NOx absorbent moves into the outer layer when the outer layer is formed by a wash-coating process in which the outer layer is formed by dipping the support member with the inner layer formed thereon in a slurry, the method of the invention is especially effective in the case where the outer layer is formed by the wash-coating process.

In the method of the invention, it is preferred to employ an oxide of an ionic electric field intensity of approximately less than 0.8 as the basic compound when one of alkaline metals, alkaline earth metals and rare earth metals is used as the NOx absorbent and alumina is used as the support material for the NOx absorbent. In the case of impregnating various oxides with the NOx adsorbent, the easiness of adhesion of the NOx absorbent to the oxide depends upon the intensity of ionic electric field or basic degree of the oxide. Specifically, the NOx absorbent is made harder to adhere to the oxide with an increase in the intensity of ionic electric field or the basic degree of the oxide. When using as the support material alumina whose intensity of ionic electric field is approximately 0.83, it is preferred to let the outer layer contain an oxide which has the intensity of ionic electric field lower than alumina in order that the alumina in the inner layer bears a large quantity of NOx absorbent. Ceria and magnesium are preferred as one of such oxides having low intensity of ionic electric field.

According to the exhaust gas purifying system of the invention which includes a catalyst which comprises a support member, an inner layer, formed on the support member, which contains the NOx capable of absorbing material for absorbing NOx in an exhaust gas under existence of oxygen and releasing the NOx while the exhaust gas reduces its oxygen concentration and an outer layer, formed over the inner layer, which contains a sulfur compound absorbing material for absorbing sulfur oxides in the exhaust gas under existence of oxygen and releasing the sulfur oxides while the exhaust gas reduces its oxygen concentration, and an oxygen concentration change means for changing the oxygen concentration of the exhaust gas, the NOx absorbent is protected by the sulfur compound absorbent from being poisoned by sulfur compound without providing the exhaust line with a bypass passge and a switching valve. The use of 80 to 360 g/L Ceria for the sulfur compound absorbent makes it possible to absorb a desired quantity of sulfur compounds in the exhaust gas even at low temperatures, which is desirable for the NOx absorbent to be protected from sulfur poisoning.

According to the method of producing the exhaust gas purifying catalyst of the invention which forms an inner layer containing a support material by which the NOx absorbent is borne on the support member, forming an outer layer containing a basic compound which is harder to bear the NOx absorbent than the support material over the inner layer, and impregnating the inner layer with a solution of NOx absorbent through the outer layer, the outer layer is prevented from bearing a large quantity of NOx absorbent.

### BRIEF DESCRIPTION OF THE DRAWINGS

The above and other objects and fetures of the invention will be best understood from the following description directed to a preferred embodiment thereof when considering in conjunction with the accompanying drawings, in which:

FIG. 1 schematically depicts an exhaust gas purifiying system in accordance with an embodiment of the invention;

FIG. 2 is a fragmentary sectional view of a catalyst in accordance with an embodiment of the invention;

FIG. 3 is a map of engine operating zones;

FIG. 4 is a flow chart illustrating an air-fuel ratio control sequence routine;

FIG. 5 is a graphical diagram of an amount of ceria (CeO₂) versus NOx absorption rate, namely a SO₂ poisoning prevention performance of the NOx absorption, of the catalyst;

FIG. 6 is a fragmentary sectional view of a catalyst in accordance with another embodiment of the invention;

FIG. 7 is a graphical diagram of NOx absorption rates with respect to various oxides contained in the outer layer of a fresh catalyst and in the outer layer of the catalyst after exposed to SO₂; and

FIG. 8 is a graphical diagram showing the relationship between Ba concentration and ion electric field intensity.

### DETAILED DESCRIPTION OF THE INVENTION

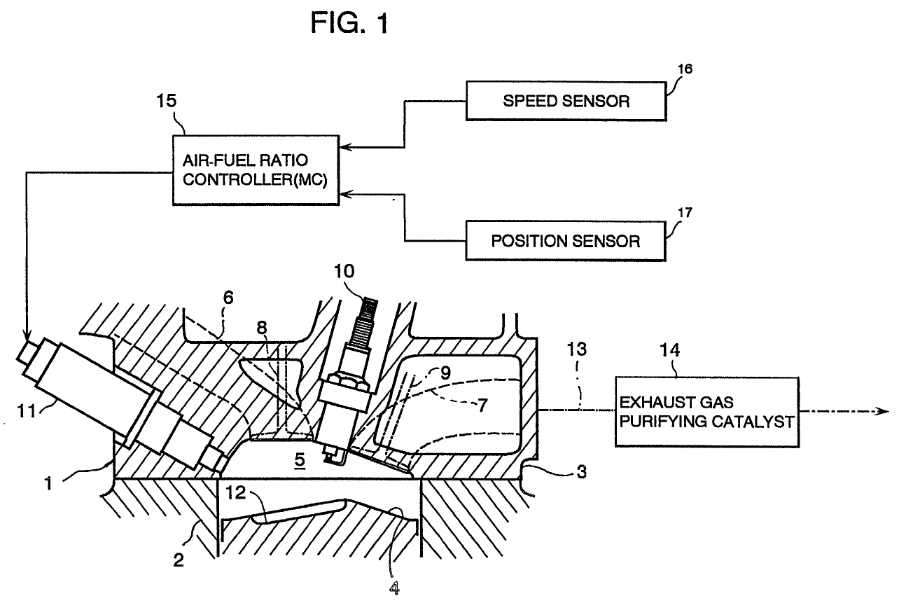

Referring to the drawings in detail, and, more particularly, FIG. 1 showing an exhaust gas purifying system in accordance with an embodiment of the invention applied to a direct fuel injection type of gasoline engine, an engine body 1 has an engine block 2 and a cylinder head 3 between which combustion chambers 5 only one of which is shown. The piston 4 slides in a cylinder bore 2a of the cylinder block 2. Each combustion chamber 5 is provided with an intake port 6 and an exhaust port 7 which are opened and shut off at a proper timing by intake valve 8 and an exhaust valve 9, respectively. The cylinder head 3 is provided with a spark plug 10 such that the distal end of the spark plug 10 extends down in the combustion chamber 5 and a fuel injector 11 such as to direct fuel below the spark plug 10. The piston 4 at its top end is formed with a cavity 12 which reflects fuel injected from the fuel injector 11 toward the spark plug 10. An exhaust line 13 extends from the exhaust port 7 and is provided with an exhaust gas purifying material. ie. an exhaust gas purifying catalyst.

The fuel injector 11 is actuated and controlled by an air-fuel ratio control unit 15 mainly comprising a microcomputer to deliver fuel according to incoming signals representing engine operating conditions such that an air-fuel ratio of an air-fuel mixture is changed between a lean condition defined by λ>1 and a rich condition defined by λ≦1. For the air-fuel ratio control, the control unit 15 receives signals from various sensors including an engine speed sensor 16 and an engine throttle position sensor 17.

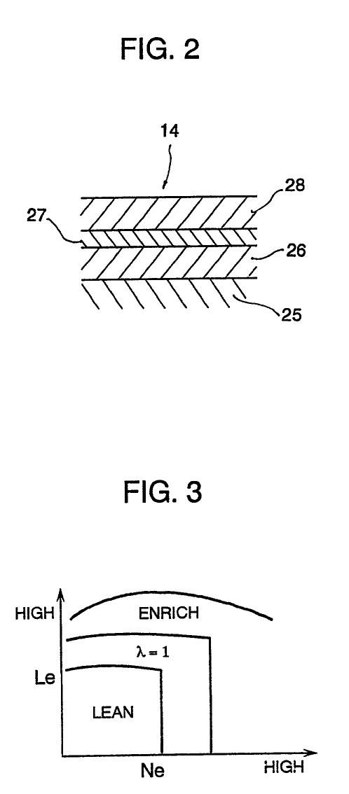

Referring to FIG. 2 showing a catalyst 14 which comprises three layers, namely an inner layer 26, an intermediate layer 27 and an outer layer 28, borne on a support bed 25 which is a monolithic honeycomb bed made of cordierite. The monolithic honeycomb bed has 400 cells per square inch and a 6 mil wall between each adjacent cells. The inner layer 6 contains barium (Ba) as a nitrogen oxide (NOx) absorbent, platinum (Pt) as a catalytic metal, and alumina, ceria and alumina hydrate (binder) as carrier materials for carrying the Ba and Pt. The intermediate layer 7 contains Pt and rhodium (Rh) as catalytic metals, and zeolite and alumina hydrate (binder) as carrier materials for carrying Pt and Rh. The outer layer 8 contains ceria as a sulfur compound absorbent and alumina hydrate (binder).

The catalyst 14 is prepared in a manner described below.

Alumina, ceria and alumina hydrate are mixed with each other at a weight ratio of 46.5:46.5:7, then water and nitric acid are added into the mixture to make a mixture slurry. The nitric acid is used to adjust pH of the mixture slurry to about 3.5 to 4. The honeycomb bed is dipped in the mixture slurry and dried at 150° C. for two hours after blowing off an excess of the mixture slurry, and then burnt at 500° C. for two hours. This process is made once to bear 78 g/L of alumina and 78 g /L of ceria on the honeycomb bed. The unit “g/L” refers to unit weight per one liter of honeycomb bed. In this instance, the total weight of the mixture is approximately 37% of the weight of the honeycomb bed.

Separately, a dinitro-diamine plutinum solution and a rhodium nitrate solution are mixed to provide a solution mixture so that a weight ratio of Pt to Rh is 75:1. Water and powdered zeolite (MFI type) are added to the solution mixture to provide a mixture slurry so that the total weight of Pt and Rh is 24 g per 1 kg of zeolite. The mixture slurry is dried by a splay-dry method and then burnt at 500° C. for two hours to form powdered zeolite bearing Pt and Rh (which is hereafter referred to Pt—Rh bearing zeolite).

The powdered Pt—Rh bearing zeolite and alumina hydrate are mixed at a weight ratio of 85 to 15, then water is added to the mixture to provide a mixture slurry. The honeycomb bed with the alumina and ceria borne thereon is dipped in the mixture slurry and dried at 150° C. for tow hours after blowing off an excess of the mixture slurry. Further it is burnt at 500° C. for two hours to let the honeycomb bed bear 20 g/L to 22 g/L of Pt—Rh bearing zeolite which is approximately 5 weight % of the honeycomb bed.

Ceria and alumina hydrate are mixed at a weight ratio of 10 to1, then water is added to the mixture to make a mixture slurry. The honeycomb bed with Pt—Rh bearing zeolite is dipped in the mixture slurry, and then the honeycomb bed is dried at 150° C. for two hours after blowing off an excess of the mixture slurry and further burnt at 500° C. for two hours to let the honeycomb bed bear 80 g/L to 360 g/L of ceria, which is approximately 20 to 90 % of the honeycomb bed.

The resultant honeycomb bed is impregnated with a mixture of a dinitro-diamine platinum solution and a barium acetate solution so as to bear 2 g/L of Pt and 30 g/L of Ba. After the impregnation, the honeycomb bed is dried at 150° C. for two hours and burnt at 500° C. for two hours to provide the catalyst 14. In this process the Ba solution and the Pt solution reach the alumina in the inner layer so that Ba and Pt are borne on the alumina without being caught by the ceria and the zeolite because of their small specific surface areas. And because ceria is hard to bear Ba.

The air/fuel ratio control unit 15 varies an air-fuel ratio by controlling a fuel-injection pulse width. The fuel injection pulse width Ta is defined by the following expression:

Ta=Tr×K

where Tr is the basic fuel-injection pulse width and K is the correction factor.

The correction factor K takes a value dictated by λ=1 for K=1, a value dictated by λ>1 for K<1, or a value dictated by λ<1 for K>1. Optimum values for the basic fuel injection pulse width Tr are experimentally determined according to changes in engine speed Ne and engine loading Ce which is represented by intake air quantity and are stored in the form of an electronic control data map. Further, the optimum values for the correction factors K are experimentally determined according to changes in engine operating condition and are stored in the form of electronic control data map.

Specifically, as shown in FIG. 3, while the engine is enough high in temperature for example, the correction factor K is less than 1 in an engine operating zone of low to intermediate engine speeds Ne and low to intermediate engine loading Le (which is a lean zone defined by λ>1 and in which an air-fuel ratio is 2 to 200 and an oxygen concentration in the exhaust gas is higher than 5%), equal to 1 in an engine operating zone of high engine speeds Ne and high engine loading Le (which is a rich zone defined by λ=1) surrounding the lean zone, and greater than 1 in an engine operating zone of extraordinary high engine speeds Ne and extraordinary high engine loading Le (which is an enriched zone defined by λ<1). On the other hand, while the engine is cold, the correction factor K is equal to 1 in an engine operating zone of low to intermediate engine speeds Ne and low to intermediate engine loading Le (which is a rich zone defined by λ=1), and greater than 1 in an engine operating zone of high engine speeds Ne and high engine loading Le (which is an enriched rich zone defined by λ>1) surrounding the rich zone.

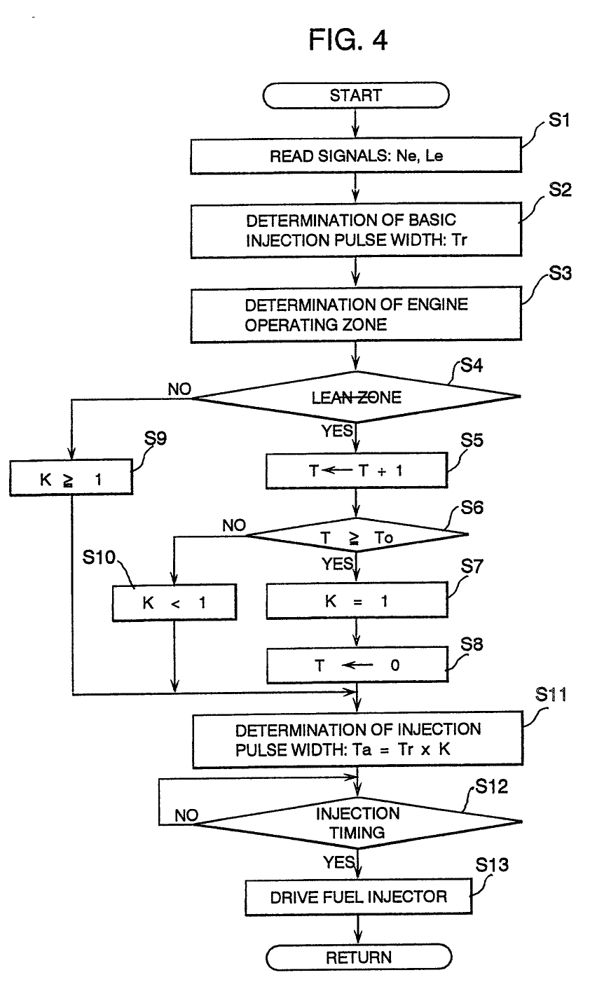

FIG. 4 is a flow chart illustrating a sequence routine of air-fuel ratio control for a microcomputer of the control unit 15. When the flow chart logic commences and control proceeds directly to a function block at step S1 where the control unit 15 reads in signals representing an engine speed Ne and an engine loading Le from the speed sensor 16 and the throttle position sensor 17. On the basis of the engine speed Ne and loading Le, a basic injection pulse width Tr and an engine operating zone are determined at steps S2 and S3, respectively. Subsequently, a judgment is made at step S4 as to whether the current engine operating condition is in the lean zone. When in the lean zone, an internal timer is actuated to count a time T at step S5. The time T is compared with a predetermined critical time To at step S6. When the time T is equal to or greater than the critical time To, the correction factor K is established to be equal to 1 (one) at step S7, and the internal timer is stopped at step S8. On the other hand, the correction factor K is established to be equal to or greater than 1 (one) at step S9 when the engine operating condition is out of the lean zone, or established to be less than 1 (one) at step S10 when the critical time To has not yet lapsed even while the engine operating condition is in the lean zone. After establishing the correction factor K, an injection pulse width Ta is determined based on the basic injection pulse width Tr and the correction factor K at step S11 . At a fuel injection timing at step S12, the fuel injector 11 is pulsed with the fuel injection pulse width Ta at step S13.

The critical time To is experimentally determined as a time from the beginning of absorption of a sulfur emission in the exhaust gas by the ceria in the outer layer 28 of the catalyst 14, namely a time at which the engine operating condition turns from the rich zone to the lean zone, to an occurrence of a significantly sharp drop in sulfur absorption performance of the ceria, namely a time immediately before saturation of sulfur compounds in the outer layer 28 of the catalyst 14. In this instance, while the engine operating condition is in the lean zone, the air-fuel ratio dictated by λ (an air excess factor) becomes high with the result of risen oxygen concentration of the exhaust gas. Consequently, the sulfur compounds in the exhaust gas are absorbed by the ceria in the outer layer 28 of the catalyst 14, so as to prevent Ba in the inner layer 26 from sulfur poisoning and to make Ba absorb nitrogen oxides (NOx) in the exhaust gas with a high efficiency. Because, even while the engine operating condition is in the lean zone, the air-fuel ratio dictated by λ intermittently attains 1 (one), it is eliminated that the outer layer 28 of the catalyst 14 is saturated with sulfur compounds or that the inner layer 26 is saturated with NOx. In other words, since the oxygen concentration of the exhaust gas drops when the air-fuel ratio of an air-fuel mixture represented by λ reaches 1 (one), Ba in the inner layer 26 of the catalyst releases NOx therefrom and is thereby restored. The released NOx is deoxidized by Pt or the like. On the other hand, the ceria in the inner layer 28 of the catalyst 14 releases sulfur compounds and is thereby restored. AT this time, the air-fuel ratio represented by λ is 1 (one), which prevents Ba from being poisoned by sulfur released from the ceria.

When restarting the engine after a stop, it may be done to count a time for which the engine operating condition is in the lean zone after a lapse of a time T before the engine stop. Further, in place of operating the engine in the rich zone (λ=1) after every specified time period, the engine may be operated in the rich zone (λ=1) at a time that ceria is saturated with sulfur compounds. The saturation of ceria with sulfur compounds is presumed to occur at a time, for example, that a specified total quantity of intake air is introduced. Furthermore, the intermittent engine operation in the rich zone (λ=1) may be continually repeated. The air-fuel ratio control may be performed by controlling an electrically operated throttle valve to vary intake air quantity in place of varying the injection pulse width.

In order to evaluate the catalyst of the invention, four sample catalysts and one comparative catalyst were prepared by the process described above. First sample catalyst had the outer layer containing ceria of 80 g/L, second one had the outer layer containing ceria of 140 g/L, third one had the outer layer containing ceria of 280 g/L and forth one had the outer layer containing ceria of 360 g/L. The comparative catalyst had no outer layer. The respective layers of each of the sample catalysts and comparative catalyst had less than 1% impurities.

NOx absorption rates (NOx purification rates ) were measured by flowing a simulated exhaust gas such as shown in TABLE I through a reactor in which each catalyst was fixed. The simulated exhaust gas was flushed at a space velocity (SV) of 55000 h⁻¹ at 350° C. During the measurement, the simulated exhaust gas initially having a composition resulting from combustion of a lean air-fuel mixture was changed to have a composition resulting from combustion of a rich air-fuel mixture (λ=1) and then, after being kept with the composition for a predetermined time period, was changed back to the initial composition again. The NOx absorption rate was measured for 130 seconds after changed back to the initial condition.

The composition of the simulated gas is summarized in the following Table I.

TABLE 1

| Composition | λ= 1 | Lean-burn condition |
|---|---|---|
| HC (propylene) | 4000 ppm C | 4000 ppm C |
| CO | 0.16% | 0.16% |
| NOx | 260 ppm | 260 ppm |
| H₂ | 650 ppm | 650 ppm |
| CO₂ | 9.75% | 9.75% |
| O² | 0.5% | 7% |
| N₂ | balance | balance |

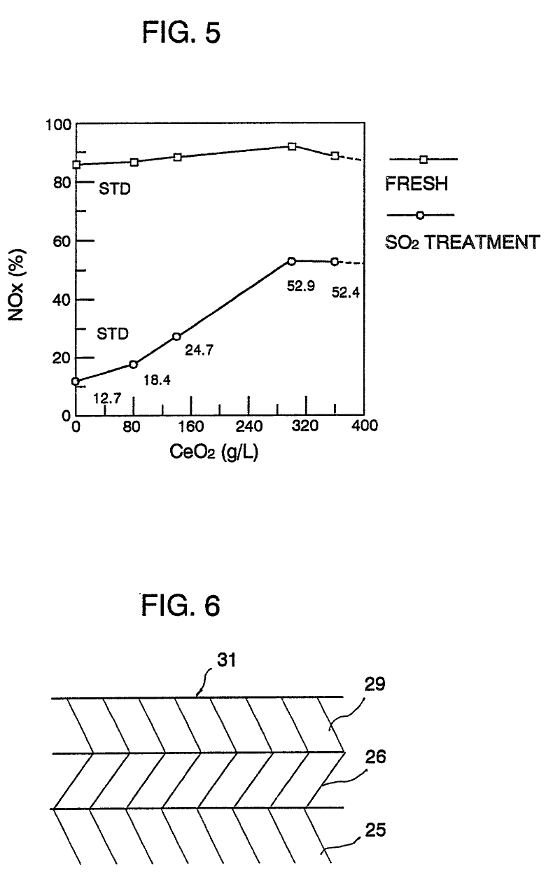

The result of the measurement NOx absorption rate of fresh catalysts is shown in FIG. 5 where data indicated by STD is of the comparative catalyst. All of the catalysts show high NOx absorption rates, approximately 90%.

Another result of the measurement of NOx absorption rate of SO₂-treated catalysts by use of the same reactor is shown in FIG. 5. The SO₂-treatment was performed by exposing each catalyst to a treatment gas for 30 min. before the NOx absorption rate measurement. The treatment gas used in the SO₂-treatment process containing 200ppm SO₂, 20% O₂ and the balance of N₂ was flushed at a space velocity of 55000 h ⁻¹ at a temperature of 350° C. for 30 min.

Further, as apparent from FIG. 5, the NOx absorption rate of the SO₂-treated catalyst is lower than that of the fresh catalyst. This result indicates that Ba as NOx absorbent in the inner layer 26 is poisoned with 21 SO₂. However, while the comparative catalyst having no outer layer which contains ceria as a sulfur compound absorbent shows a NOx absorbent rate of 12.7%, the sample catalysts having the outer later provides an increase in NOx absorbent rate as a ceria content of the outer layer increases and attains a NOx absorbent rate of approximately 53%. This result indicates that ceria in the outer layer helps to prevent the NOx absorbent ( Ba ) in the inner layer from being poisoned by SO₂. The intermediate layer 27 activates NOx to cause the NOx absorbent in the inner layer 26 to promote absorption of NOx. It is also proved from the result shown in FIG. 5 that the NOx absorbent is effectively prevented from SO₂ poisoning when the content ratio of ceria to barium is over 8/3, more preferably over 28/3. Practically, however, the content ratio of ceria to barium between 5 and 20/3 is recommended in view of preventing the outer layer 28 from separation.

It is summarized from the above evaluation that an outer layer containing a sulfur compound absorbent such as ceria formed as a part of a catalyst having a NOx absorbent effectively prevents the NOx absorbent from sulfur poisoning thereof and can keep its NOx absorbing performance. While NOx absorbed in the NOx absorbent is released when an enriched air-fuel mixture is burnt, according to the catalyst of the invention, the released NOx is reduced and purified by Pt supported on alumina in the inner layer 26, and Pt and Rh supported on zeolite in the intermediate layer 27.

FIG. 6 shows a double-layered catalyst 31 comprising an inner layer 26 and an outer layer 29. It has no intermediate layer like the previously discussed three-layered catalyst. The inner layer 26 of the catalyst 31 has the same structure and composition as that of the three-layered catalyst 14 shown in FIG. 2. The outer layer 29 contains Pt and Rh as catalytic metals , zeolite as support materials for the catalytic metals, ceria as a sulfur compound absorbent and alumina hydrate (binder). In other words, the outer layer 29 contains both compositions of the intermediate layer and the outer layer of the three-layered catalyst 14 shown in FIG. 2. Thus the outer layer 29 of the catalyst 31 has an ability that ceria can avoid the NOx absorbent (Ba) in the inner layer 26 from being poisoned by a sulfur compound by absorbing it in the exhaust gas and also that Pt and Rh supported on zeolite can activate NOx in the exhaust gas so as to promote NOx absorption by the NOx absorbent in the inner layer 26.

Examination was conducted to evaluate oxides of various materials, such as cerium (Ce), titanium (Ti), cuprum (Cu), tungsten (W), zirconium (Zr), nickel (Ni), iron (Fe) and cobalt (Co), composing the outer layer of the catalyst 14. By means of the process previously described, an oxide of each material and alumina hydrate were mixed at a weight ratio of 10:1, and is added to water to provide a slurry. The honeycomb bed bearing 20 g/L to 22 g/L of Pt—Rh bearing zeolite was dipped in the mixture slurry and then dried at 150° C. for two hours after blowing off an excess of the mixture slurry. The honeycomb bed was further burnt at 500° C. for two hours. This process was made to bear 100 g/L of each oxide on the honeycomb bed and 6 g/L Pt.

NOx absorption rates of the catalysts provided as above and before SO₂ treatment were measured to make comparative evaluation. In the measurements, excepting that the SO₂ concentration used in the SO₂ treatment was 500 ppm, the same measurement conditions were applied.

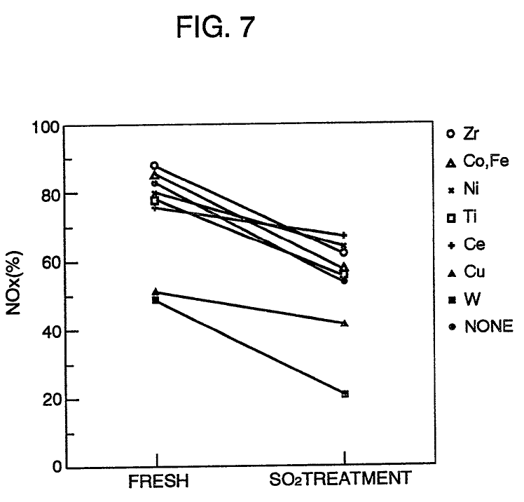

The result of the measurements is shown in FIG. 7. In FIG. 7, a comparative catalyst is indicated by “none” and has only the inner layer 26 with 6 g/L Pt borne thereon. It is apparent from FIG. 7 that the sample catalysts after SO₂ treatment in which oxides of Ce, Ti, Cu, W, Zr, Ni, Fe and Co are employed, respectively, have NOx absorption rates higher than that of the comparative catalyst. This means that these oxides are useful for preventing the NOx absorbent from sulfur poisoning and, in particular, that an oxide of Ce, i.e. ceria significantly reduces aggravation of NOx absorption rate.

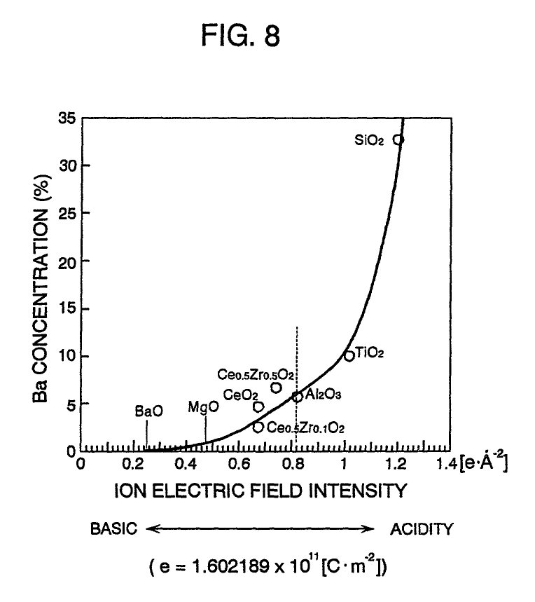

In order to investigate the relationship between the intensity of ionic electric field of an oxide in the outer layer 29 and the Ba concentration of the outer layer 29, samples of the catalyst 14 were prepared. The sample catalyst had an outer layer 29 containing CeO₂, TiO₂, Al₂O₃, SiO₂ and Ce—Zr compound oxide, respectively. Each sample catalyst contained 100 g/L associated oxide, 6 g/L Pt and 30 g/L Ba, Measurements were made to detect the intensity of ionic electric field of the oxide in the outer layer 29 and the Ba concentration of the outer layer 29. The result of the measurements is shown in FIG. 8.

As apparent from FIG. 8, it is proved that the Ba concentration increases as the intensity of ionic electric field rises. In the case that Al₂O₃is used as a support material in the inner layer 26, when using an oxide which has an intensity of ionic electric field lower than the intensity of ionic electric field (approximately 0.83) of Al₂O₃ in the outer layer 29 and which is, for example, any one of CeO₂ and Ce—Zr compound oxide, it is possible to avoid unevenly much distribution of Ba in the outer layer and to bear Ba more in the inner layer. MgO, which has a low intensity of ionic electric field, has an effect of preventing unevenly much distribution of Ba in the outer layer.

When a rich air-fuel mixture is burnt, SOx in the exhaust gas passes through the catalyst 14, 31 without being caught, and the sulfur compound absorbent of the catalyst 14, 31 releases sulfur oxides (SOx). This SOx reacts with water in the exhaust gas to yield H₂S which, if discharge into the air, emits a bad smell. To avoid an H₂S emission, H₂S absorbent such as NiO and Fe₂O₃ may be placed downstream from the catalyst 14, 31 in the exhaust line.

While the invention has been described in detail in connection with the preferred embodiments thereof, it is not intended to limit the invention to the particular forms set forth, but, on the contrary, it is intended to cover such alternatives, modifications and equivalents as may be included within the spirit and scope of the invention as defined by the appended claims.

What is claimed is:

1. A method of producing an exhaust gas purifying catalyst which comprises a support member and Ba coated on said support member and containing a NOx absorbing material which absorbs NOx in an exhaust gas from an engine in the presence of 5% or more of oxygen and releases said NOx absorbed thereby while the exhaust gas reduces its oxygen concentration, said exhaust gas purifying catalyst producing method comprising the steps of:
forming an inner layer comprising a bearing material and coated on said support member;
forming an outer layer coated over said inner layer and comprising one of ceria, Ce—Zr composite oxides and magnesia; and
dipping said support member in a Ba solution and then drying and baking said inner layer and said outer layer.

2. A method of producing an exhaust gas purifying catalyst as defined in claim 1, wherein said bearing material is alumina.

3. A method of producing an exhaust gas purifying catalyst as defined in claim 1, wherein said Ba solution is a solution of Ba acetate.

4. A method of producing an exhaust gas purifying catalyst which comprises a support member and Ba coated on said support member which absorbs NOx in an exhaust gas from an engine in a lean operating state where 5% or more of oxygen is contained while the engine operates in a lean operating zone and releases said NOx absorbed when the engine enters a λ-operating state where an air-fuel ratio temporarily equal to or less than 1, said exhaust gas purifying catalyst producing method comprising the steps of:
forming an inner layer comprising a bearing material and coated on said support member;
forming an outer layer coated over said inner layer and comprising one of ceria, Ce—Zr composite oxides and magnesia and dipping said support member in a Ba solution and then drying and baking said inner layer and said outer layer.
